(19) United States
(12) Patent Application Publication
(10) Pub. No.: US 2022/0095537 A1
(43) Pub. Date: Mar. 31, 2022

(54) BAFFLE SYSTEM FOR LAWN MOWER CUTTING DECK

(71) Applicant: Ariens Company, Brillion, WI (US)

(72) Inventors: Michael Rukamp, Brillion, WI (US); Edward Boldt, Jr., Brillion, WI (US); Suzanne Zampaloni, Brillion, WI (US)

(21) Appl. No.: 17/424,121

(22) PCT Filed: Feb. 11, 2020
(86) PCT No.: PCT/US20/17741

§ 371 Date: Jul. 19, 2021

Related U.S. Application Data
(60) Provisional application No. 62/803,676, filed on Feb. 11, 2019.

(51) Int. Cl. A01D 34/81; A01D 34/73

(52) U.S. Cl. CPC A01D 34/81; A01D 2101/00; A01D 34/73

(57) ABSTRACT

A lawn mower includes a cutting deck with first and second cutting blades to form clippings beneath the cutting deck and a baffle system to direct the clipping through a discharge opening. The baffle system includes a baffle wall that at least partially surrounds the first and second cutting blades to define first and second cutting chambers. The baffle wall includes a front baffle wall portion having a front guide surface to guide the clippings from the first and second cutting chambers towards the discharge opening, and a rear baffle wall portion having a concave guide surface and an end positioned between the first cutting chamber and the discharge opening. A discharge transition area is positioned between the first cutting chamber and the discharge opening.

### CROSS REFERENCE TO RELATED APPLICATIONS

This application claims priority to U.S. Provisional Patent Application No. 62/803,676, filed Feb. 11, 2019, the entirety of which is hereby incorporated by reference.

### FIELD OF THE INVENTION

The present invention relates to lawn mowers and, more particularly, to baffle systems for use lawn mower cutting decks.

### SUMMARY

In one embodiment, the invention provides a cutting deck for a lawn mower. The cutting deck includes a cutting deck pan having an upper wall, sidewalls extending downwardly from the upper wall, and a discharge opening defined in the sidewalls. A first cutting blade is rotatably mounted beneath the upper wall. The first cutting blade is configured to rotate within a first rotation zone. A second cutting blade is rotatably mounted beneath the upper wall. The second cutting blade is configured to rotate within a second rotation zone. The first and second cutting blades are configured to cut vegetation and form clippings beneath the cutting deck pan. A baffle system is coupled to the cutting deck pan and extends downwardly from the upper wall. The baffle system has a baffle wall that at least partially surrounds the first cutting blade and the second cutting blade to define a first cutting chamber and a second cutting chamber. The baffle wall includes a front baffle wall portion having a front guide surface configured to guide the clippings from the first and second cutting chambers towards the discharge opening, and a rear baffle wall portion having a concave guide surface and an end positioned between the first cutting chamber and the discharge opening. A discharge transition area is positioned between the first cutting chamber and the discharge opening. The discharge transition area is defined by a linear segment of the baffle wall that extends from the end of the rear baffle wall portion to the discharge opening in a direction away from the front baffle wall portion and a contoured segment of the baffle wall formed on the front guide surface that extends from approximately midway within the first cutting chamber to the discharge opening. The contoured segment curves away from the rear baffle wall portion. The contoured segment is positioned opposite the linear segment such that a size of the discharge opening increases away from the first and second cutting chambers.

In another embodiment, the invention provides a cutting deck for a lawn mower. The cutting deck includes a cutting deck pan having an upper wall, sidewalls extending downwardly from the upper wall, and a discharge opening defined in the sidewalls. A first cutting blade is rotatably mounted beneath the upper wall. The first cutting blade is configured to rotate within a first rotation zone. A second cutting blade is rotatably mounted beneath the upper wall. The second cutting blade is configured to rotate within a second rotation zone. A baffle system is coupled to the cutting deck pan and extends downwardly from the upper wall. The baffle system has a baffle wall that at least partially surrounds the first cutting blade and the second cutting blade to define a first cutting chamber and a second cutting chamber. The baffle wall includes a rear baffle wall portion having a concave guide surface that forms a peak between the first cutting chamber and the second cutting chamber, and a front baffle wall portion having a front guide surface having a transition area positioned between the second cutting chamber and the first cutting chamber and a curved segment that extends from the transition area to form an apex approximately midway within the first cutting chamber and proximate the first rotation zone. The curved segment being convex away from the first rotation zone.

Other aspects of the invention will become apparent by consideration of the detailed description and accompanying drawings.

### BRIEF DESCRIPTION OF THE DRAWINGS

FIG. 1 is a perspective view of a lawn mower, the lawn mower including a cutting deck.

FIG. 2 is a top perspective view of the cutting deck.

FIG. 3 is a bottom perspective view of the cutting deck.

FIG. 4 is a bottom plan view of the cutting deck.

FIG. 5A schematically illustrates clippings being discharged from a conventional cutting deck.

FIG. 5B schematically illustrates clippings being discharged from the cutting deck of FIGS. 2-4.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

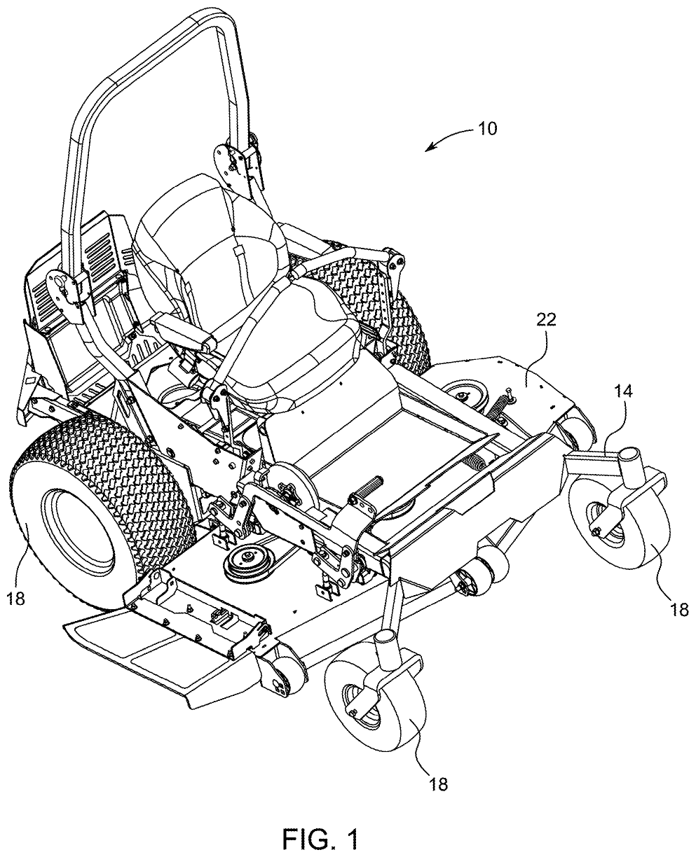

FIG. 1 illustrates a lawn mower 10. In the illustrated embodiment, the lawn mower 10 is a riding lawn mower. More specifically, the lawn mower is a zero-turn radius (ZTR) riding lawn mower. In other embodiments, the lawn mower 10 may be other types of mowers, such as a tractor, standing lawn mower, or walk behind lawn mower. The illustrated lawn mower 10 includes a frame 14, a prime mover (e.g., an engine, an electric power supply, etc.) supported by the frame 14, ground engagement elements 18 moveably coupled to the frame 14, and a cutting deck 22 supported by the frame 14. The prime mover may be coupled to one or more of the ground engagement elements 18 to drive (e.g., rotate) the ground engagement elements 18. The illustrated ground engagement elements 18 include wheels, but may alternatively include tracks and the like.

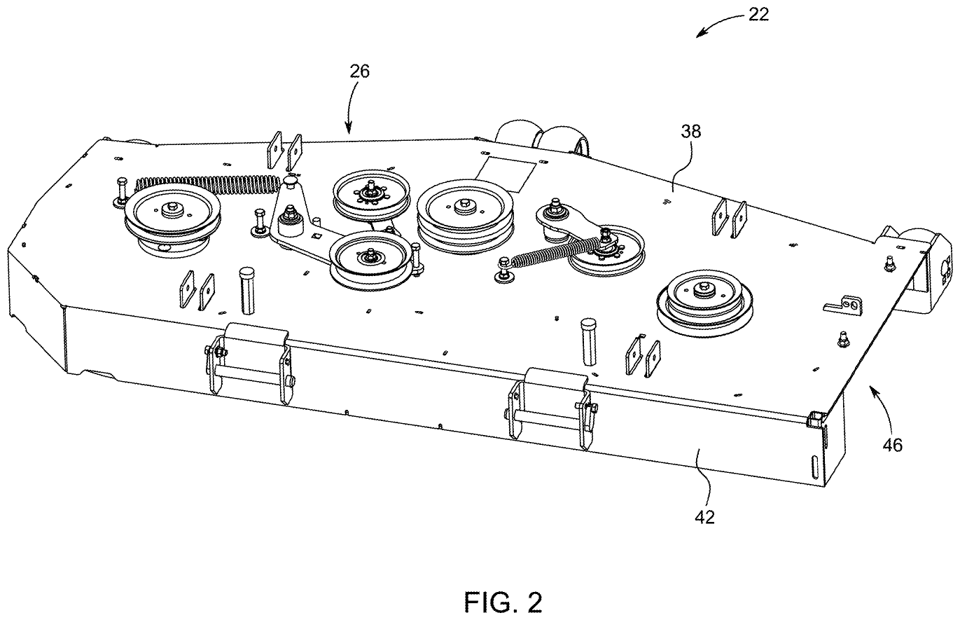

As shown in FIGS. 2-4, the cutting deck 22 includes a deck pan 26, a plurality of cutting blades 30, and a baffle system 34. The deck pan 26 has an upper wall 38 and sidewalls 42 extending downwardly from the upper wall 38. The deck pan 26 also has a discharge opening 46 defined in the sidewalls 42. The discharge opening 46 is configured to discharge clippings out of the cutting deck 22. In the illustrated embodiment, the discharge opening 46 is formed in a side of the cutting deck 22, relative to a direction of travel of the lawn mower 10. In other embodiments, the discharge opening 46 may be formed elsewhere on the cutting deck 22.

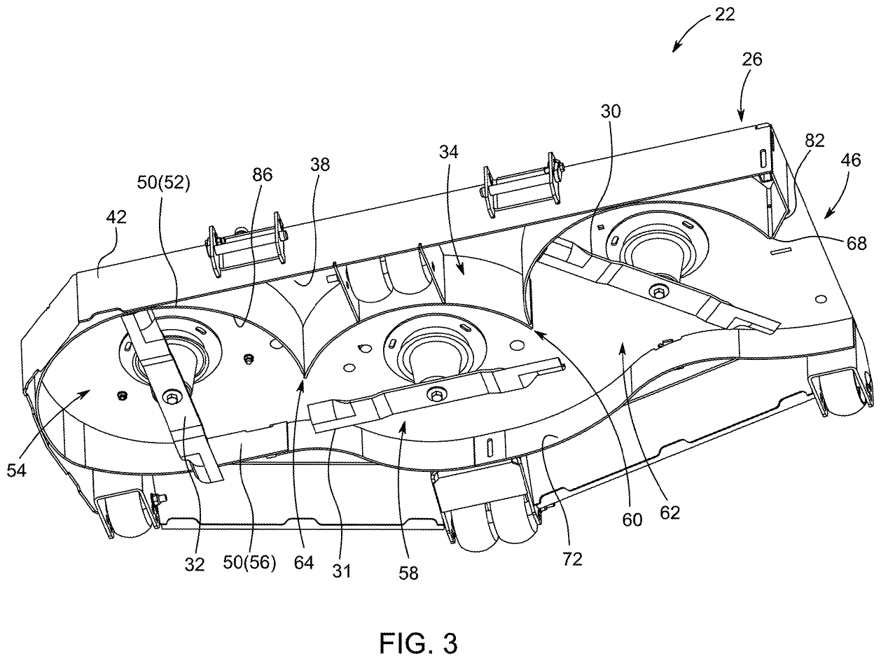

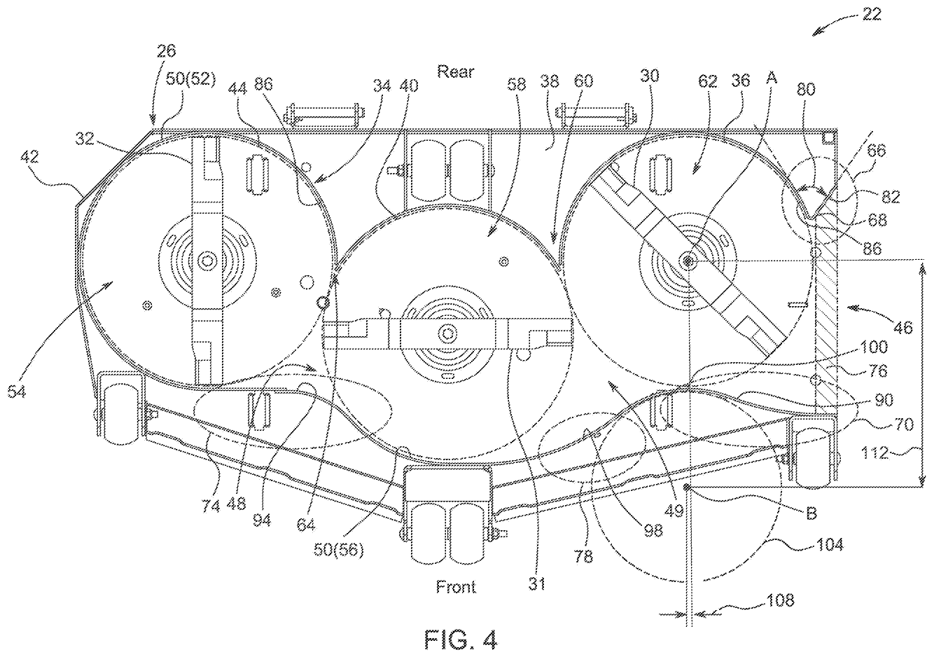

As shown in FIGS. 3 and 4, the cutting blades 30 are rotatably mounted beneath the deck pan 26. In the illustrated embodiment, the cutting deck 22 includes a first cutting blade 30, a second cutting blade 31, and a third cutting blade 32. In other embodiments, the cutting deck 22 may include fewer or more cutting blades. The cutting blades 30, 31, 32 are rotatable relative to the deck pan 26 to cut vegetation beneath the cutting deck 22. In the illustrated embodiment, the cutting blades 30, 31, 32 are operably coupled to the prime mover (e.g., via a belt drive mechanism, FIG. 2.) to rotate the cutting blades 30, 31, 32. In other embodiments, the cutting deck 22 may include electric direct drive deck motors to drive the cutting blades 30. In the illustrated embodiment, the cutting blades 30 are operable to rotate in a counter-clockwise direction (as viewed in FIG. 4) to cut vegetation and form clippings that are guided out of the cutting deck 22 along the baffle system 34.

The baffle system 34 is coupled to the deck pan 26 and extends downwardly from the upper wall 38. The baffle system 34 is composed of baffle walls 50 that at least partially surrounds the first cutting blade 30, the second cutting blade 31, and the third cutting blade 32 to define a first cutting chamber 62, a second cutting chamber 58, and a third cutting chamber 54. In the illustrated embodiment, the first cutting chamber 62 is formed around the first cutting blade 30, which is closest to the discharge opening 46. The second cutting chamber 58 is formed around the middle or second cutting blade 31. The third cutting chamber 54 is formed around the third cutting blade 32, which is furthest from the discharge opening 46.

As shown in FIG. 4, the baffle system 34 includes a rear baffle wall portion 52 that defines rear sections of the first, second, and third cutting chambers 62, 58, 54. The baffle system 34 also includes a front baffle wall portion 56 that defines front sections of the first, second, and third cutting chambers 62, 58, 54. Each of the first, second, and third cutting blades 30, 31, 32 rotate within respective blade rotation zones 36, 40, 44 that circumscribe distal ends of the cutting blades 30, 31, 32 in each cutting chamber 54, 58, 62. The blade rotation zones 36, 40, 44 generally define the circumference of each cutting chamber 54, 58, 62. Positioned between each blade rotation zone 36, 40, 44 are transition zones 48, 49 that are outside of the range of the blade rotation zones 36, 40, 44. In the illustrated embodiment, a first transition zone 48 is defined as the zone positioned between the third cutting chamber 54, the second cutting chamber 58, and a portion of the front baffle wall portion 56. A second transition zone 49 is defined as the zone positioned between the second cutting chamber 58, the first cutting chamber 62, and a portion of the front baffle wall portion 56.

The rear baffle wall portion 52 includes a concave guide surface 86. The concave guide surface 86 forms a first abrupt peak 60 between the first cutting chamber 62 and the second cutting chamber 58. The concave guide surface 86 also forms a second abrupt peak 64 between the second cutting chamber 58 and the third cutting chamber 54. The concave guide surface 86 is constructed to conform with or be concentric to the rear portion of the blade rotation zones 36, 40, 44 to direct clippings in the rear portion of the baffle system 34 towards the front baffle wall portion 56. The rear baffle wall portion 52 includes an end 68 positioned between the first cutting chamber 62 and the discharge opening 46. In the illustrated embodiment, the concave guide surface 86 is formed of three curved segments or a half circles that terminate at the first and second abrupt peaks 60, 64. In other embodiments, the entire rear baffle portion wall 52 may be formed of a single piece of material that defines the rear section of each cutting chamber 54, 58, 62. In some embodiments, the entire baffle system 34 may be formed of a single piece.

The front baffle wall portion 52 includes a front guide surface 72 that forms a continuously curved surface from the third cutting chamber 54 to the discharge opening 46. In the illustrated embodiment, the front guide surface 72 is constructed to direct clipping from the third cutting chamber 54 to the second cutting chamber 58, from the second cutting chamber 58 to the first cutting chamber 62, and from the first cutting chamber 62 towards the discharge opening 46.

The front guide surface 72 includes a first transition area 74 positioned adjacent the first transition zone 48 between the third cutting chamber 54 and the second cutting chamber 58. The first transition area 74 directs the clippings from the third cutting chamber 54 to the second cutting chamber 58. The first transition area 74 includes an extended, contoured segment 94. The extended, contoured segment 94 is initially linear as the segment extends out of the third cutting chamber 54 and is then convex toward the second cutting chamber 58. The first transition area 74 is devoid of any abrupt peaks that extend towards the rear baffle wall portion 52 within the first transition zone 48. The absence of abrupt peaks and the geometry of the extended contoured segment 94 in the first transition area 74 reduces the amount of clippings that may form clumps within or fail to exit the third cutting chamber 54. As a result, the third cutting blade 32 is able disperse the clippings from the third cutting chamber 54 through the first transition zone 48 and into the second cutting chamber 58 for processing through the cutting deck 22.

The front guide surface 72 includes a second transition area 78 positioned adjacent the second transition zone 49 between the second cutting chamber 58 and the first cutting chamber 62. The second transition area 78 directs the clippings from the second cutting chamber 54 to the first cutting chamber 62. The second transition area 78 includes a drooped, contoured segment 98. The drooped, contoured segment 98 is slightly concave away from the second cutting chamber 58 and transitions to being convex away from the third cutting chamber 62. A curved segment extends from the drooped, contoured segment 98 and forms an apex 100 positioned approximately midway within the first cutting chamber 62 and proximate to a front portion of the blade rotation zone 36 of the first cutting blade 30. It should be appreciated that the apex 100 may form a relative extrema or an absolute extrema of the front baffle wall portion 56. In some embodiment, the apex 100 may be the portion of the front baffle wall portion 56 that is closest to the rear baffle wall portion 52 (i.e., an absolute extrema). In other embodiments, the apex 100 may be the portion of the front baffle wall portion 56 adjacent that first cutting chamber 62 that is closest to the rear baffle wall portion 52 (i.e., a relative extrema.), In the illustrated embodiment, the apex 100 is a relative extrema. It should also be appreciated that while the first and second transition areas 74, 78 are illustrated as curved surfaces, that the first and second transition area 74, 78 may be flat.

With continued reference to FIG. 4, the profile of the curved segment extending from the drooped, contoured segment 98 to the apex 100 is illustrated with respect to a baffle wall center having a center point B that is offset (e.g., towards the front of the cutting deck) a center point A of the first rotation zone 36. The baffle wall circle 104 defines an outer circumference that is equidistant from the center point B. The curved segment of the front baffle wall portion 56 extends from the drooped, contoured segment 98 of the second transition area 78 to form the apex 100 approximately midway within the first cutting chamber 62 while conforming to a portion of the circumference of baffle circle 104.

In the illustrated embodiment, the center point A of the first rotation zone 36 is offset the center point B of the baffle circle 104 a first distance 108 (e.g., a left-to-right direction or side-to-side direction that is perpendicular to a direction of travel of the lawn mower 10 and the cutting deck 22) and a second distance 112 (e.g., a front to back direction). The first and second distances 108, 112 may vary based on the size of the mower deck 22. For example, the first distance 108 may be relatively small (e.g., offset approximately three inches). In the illustrated embodiment, the center point A is closer to the discharge opening than the center point B. In other embodiments, center point B may be positioned closer to the discharge opening 46 than the center point A or approximately in line with the center point A (e.g., the first distance 108 is approximately zero).

The second distance 112 may vary so the apex 100 of the front baffle wall portion 56 is proximate the outer circumference of the first rotation zone 36. For example, the apex 100 may be positioned less than approximately three inches from the outer circumference of the first rotation zone 36. In some embodiments, the distance between the apex 100 and the first rotation zone 36 may be proportional to the diameter of the cutting deck 22. For example, the distance may be approximately less than five percent of the diameter of the cutting deck 22. In other embodiments, the apex 100 may be positioned greater than approximately three inches from the first blade rotation zone.

In the illustrated embodiment, a tangential surface of the curved surface (e.g., at the apex 100) is parallel to a tangential surface of the first blade rotation zone 36 proximate to the apex 100. In other words, the front baffle wall portion 56 is devoid of any portions that are concentric with and convex towards the blade rotation zone 36. Rather, the curved segment of the front baffle wall portion 56 that defines apex 100 is convex away from first rotation zone 36 and concave towards the center point B of the baffle circle 104.

The second transition area 78 is also devoid of any abrupt peaks that extend towards the rear baffle wall portion 52 within the second transition zone 49. Rather, the drooped, contoured segment 98 forms a continuous surface that extends towards the apex 100 and is angled towards the end 68 of the rear baffle portion 52. The absence of abrupt peaks and the geometry of the drooped, contoured segment 98 and the apex 100 reduces the amount of clippings that may form clumps within or fail to exit the second cutting chamber 58. As a result, the second cutting blade 31 is able disperse the clippings from the second cutting chamber 58 through the second transition zone 49 and into the first cutting chamber 62.

With continued reference to FIG. 4, a discharge transition area 76, or third transition area, is positioned between the first cutting chamber 62 and the discharge opening 46. The discharge transition area 76 extends from the rear baffle wall portion 52 in a first discharge area 66 and extends from the front baffle wall portion 56 in a second discharge area 70. In the illustrated embodiment, the discharge transition area 76 is defined by a linear segment 82 of the baffle wall 50 in the first discharge area 66 that extends from the end 68 of the rear baffle wall portion 52 to the discharge opening 46. The linear segment 82 is angled toward the rear of the cutting deck 22 in a direction away from the front baffle wall portion 56 to increase the size (e.g., the width from the linear segment 82 to the second discharge area 70) of the discharge opening 46. That is, the end 68 of the rear baffle wall portion 52 forms a jog between the linear segment 82 and the concave guide surface 86 of the first cutting chamber 62 to define an angle between the linear segment 82 and the concave guide surface 86. The jog at least partially increases a size (e.g., width or volume) of the discharge transition area 76 (and, thereby, the discharge opening 46) as the discharge transition area 76 extends away from the first cutting chamber 62. In some embodiments, the angle is less than 80 degrees. In other embodiments, the angle is between 55 degrees and 65 degrees. In the illustrated embodiment (e.g., a cutting deck that has a diameter of 48 inches), the angle is approximately 65 degrees. In other embodiments, (e.g., larger diameter cutting decks) the angle may be approximately 55 degrees.

The discharge transition area 76 is further defined by a contoured segment 90 of the baffle wall 50 in the second discharge area 70 that is formed on the front guide surface 72. The contoured segment 90 extends from the apex 100 of the curved surface approximately midway within first cutting chamber 62 to the discharge opening 46. The contoured segment 90 is positioned opposite the linear segment 82 in the discharge transition area 72 and curves away from the rear baffle wall portion 52 to also increase the size (e.g., width or volume) of the discharge opening 46 as the discharge transition area 76 extends away from the first cutting chamber 62. The contoured segment 90 is initially conforms with the outer circumference of the baffle wall circle 104 that is convex towards the first cutting chamber 62 and becomes concave away from the first cutting chamber 62 (e.g., curves towards the front of the cutting deck 22) the contoured segment 90 approaches the discharge opening 46. The second discharge area 70 helps reduce clipping clumping and improve distribution of clippings from the first cutting chamber 62 out of the discharge opening 46.

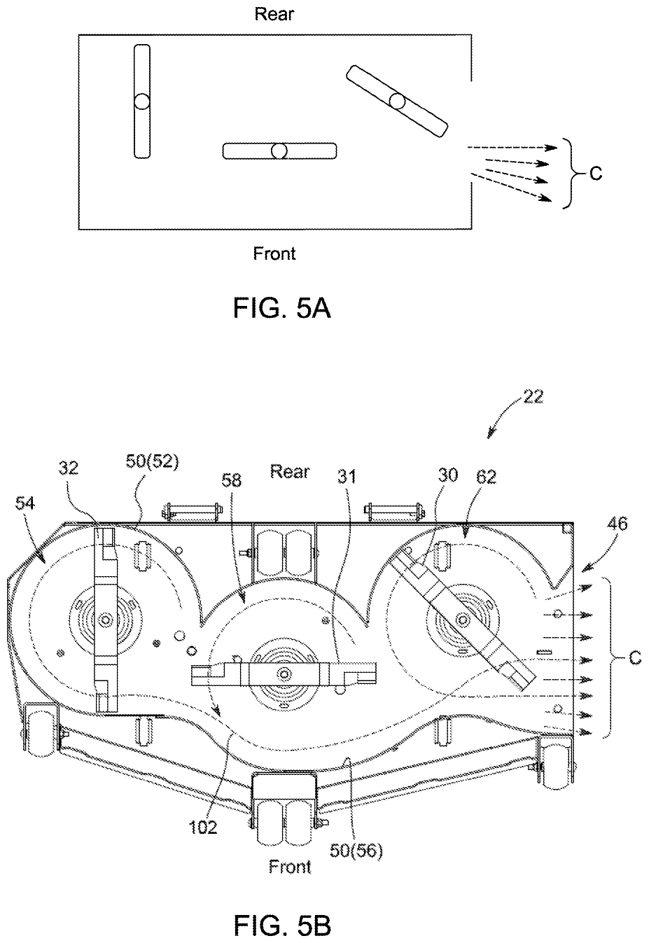

In conventional cutting decks, clippings C may be biased toward the front of the discharge opening when being expelled from the cutting deck, as schematically shown in FIG. 5A. As such, the clippings C are all forced out of the cutting deck through a relatively small portion of the discharge opening and may clump together.

The cutting deck 22 with the baffle system 34 described above helps evenly disperse the clippings C across the entire width or area of the discharge opening 46, as shown in FIG. 5B, thereby reducing clumping. That is, the combination of the first and second discharge areas 66, 70 and the first and second transition areas 74, 78 allows the cutting deck 22 to process the clippings through the cutting chambers 54, 58, 62 and equally disperse the grass clippings out of the discharge opening 46.

With reference to FIGS. 4 and 5B, during operation of the cutting deck 22, the first, second, and third cutting blades 30, 31, 32 rotate counter-clockwise (as viewed in the figures). The third cutting blade 32 guides the clippings formed in the third cutting chamber 54 along the concave guide surface 86 of the third cutting chamber 54 and towards the first transition area 74 on the front baffle wall portion 56. The contoured segment 94 of the first transition area 74 directs the clippings from the third cutting chamber 54 towards the second cutting chamber 58 along a flow path 102 (e.g., that is adjacent the contoured segment 94). As a result, the clippings are dispersed in the second cutting chamber 58 so the second cutting blade 31 is able to processes the clippings in the second cutting chamber 58.

The second cutting blade 31 guides the clippings formed in the second cutting chamber 58 along the concave guide surface 86 of the second chamber 58 and towards front baffle wall portion 56. The clippings that entered the second cutting chamber 58 from the third cutting chamber 54 and the clippings from the second cutting chamber 58 mix together (e.g., along the flow path 102). The second cutting blade 31 guides the combined clippings along the front baffle wall portion 56 and towards the second transition area 78. The drooped, contoured segment 98 of the second transition area 78 guides the combined clipping in the second cutting chamber 58 into the first cutting chamber 62. The geometry of the drooped, contoured segment 98 and the curved segment that forms the apex 100 approximately midway within the first cutting chamber 62 directs the combined clippings in a rearward direction towards the rear baffle wall portion (e.g., towards the end 68 of the rear baffle wall portion 50). As, a result, the first cutting blade 30 in the first cutting chamber 62 is able to processes the combined clipping from the third and second cutting chambers 54, 58 towards the discharge opening 46.

The first cutting blade 30 guides the clippings formed in the first cutting chamber 62 along the concave guide surface 86 of the first cutting chamber 62, beyond the apex 100, and towards the contoured segment 90 of the discharge transition area 76. At the same time, the combined clippings from the third and second cutting chambers 54, 58 enter the first cutting chamber 62 along the drooped, contoured segment 98 via the flow path 102. The construction of the first cutting chamber 62 allows the majority of the clippings cut in the first cutting chamber 62 to disperse towards the contoured segment 90 of the discharge transition area 76 while the combined clippings are moving along the flow path 102 from the third and second cutting chambers and towards the linear segment 82 of the discharge transition area 76. As a result, the first cutting blade 30 interacts with the combined clipping to eject the clippings (C) out of the discharge opening 46 between the contoured segment 90 and the linear segment 82 of the discharge transition area 72. The clippings are dispersed generally along the entire width of the discharge opening 46, rather than only a portion of the discharge opening 46.

Various features and advantages of the invention are set forth in the following claims.

1. A cutting deck for a lawn mower, the cutting deck comprising:
a cutting deck pan having an upper wall, sidewalls extending downwardly from the upper wall, and a discharge opening defined in the sidewalls;
a first cutting blade rotatably mounted beneath the upper wall, the first cutting blade being configured to rotate within a first rotation zone;
a second cutting blade rotatably mounted beneath the upper wall, the second cutting blade being configured to rotate within a second rotation zone, the first and second cutting blades being configured to cut vegetation and form clippings beneath the cutting deck pan;
a baffle system coupled to the cutting deck pan and extending downwardly from the upper wall, the baffle system having a baffle wall that at least partially surrounds the first cutting blade and the second cutting blade to define a first cutting chamber and a second cutting chamber, the baffle wall comprises:
a front baffle wall portion having a front guide surface configured to guide the clippings from the first and second cutting chambers towards the discharge opening, and
a rear baffle wall portion having a concave guide surface and an end positioned between the first cutting chamber and the discharge opening; and
a discharge transition area positioned between the first cutting chamber and the discharge opening, the discharge transition area at least partly defined by a contoured segment of the baffle wall formed on the front guide surface that extends from approximately midway within the first cutting chamber to the discharge opening, the contoured segment curving away from the rear baffle wall portion.

2. The cutting deck of claim 21, wherein the end of the rear baffle wall portion forms a jog between the concave guide surface of the rear baffle wall portion and the linear segment of the discharge transition area that defines an angle between the linear segment and the concave guide surface.

3. The cutting deck of claim 2, wherein the angle is a less than 80 degrees.

4. The cutting deck of claim 1, further comprising a third cutting blade rotatably mounted beneath the cutting deck pan, the third cutting blade being configured to rotate within a third rotation zone, wherein the baffle wall at least partially surrounds the third cutting blade to define a third cutting chamber.

5. The cutting deck of claim 4, wherein the concave guide surface of the rear baffle wall portion forms a first peak between the first cutting chamber and the second cutting chamber and a second peak between the second cutting chamber and the third cutting chamber, wherein the first peak and the second peak point towards the front baffle wall portion.

6. The cutting deck of claim 5, wherein the concave guide surface conforms with and are concave towards a portion of the first rotation zone, the second rotation zone, and the third rotation zone of the first, second, and third cutting blades.

7. The cutting deck of claim 6, wherein the front baffle wall portion has a first transition area positioned between the third cutting chamber and the second cutting chamber to direct the clippings from the third cutting chamber to the second cutting chamber and a second transition area positioned between the second cutting chamber and the first cutting chamber to direct the clippings from the second cutting chamber to the first cutting chamber, wherein the first transition area and the second transition area are continuously curved and devoid of abrupt peaks that extend towards the rear baffle wall portion.

8. The cutting deck of claim 7, wherein the first transition area comprises an extended contoured segment that is initially linear as the extended contoured segment extends out of the first cutting chamber and is then convex toward the second cutting chamber.

9. The cutting deck of claim 8, wherein the second transition area comprises a drooped contoured segment that is slightly concave away from the second cutting chamber.

10. The cutting deck of claim 8, wherein the front baffle wall portion comprises a curved segment that extends from the second transition area to form an apex proximate the first rotation zone, wherein the transition area and the curved segment are continuously curved, wherein the curved segment is convex away from the first rotation zone.

11. A lawn mower comprising:
a frame;
a prime mover supported by the frame;
a plurality of ground engagement elements moveably coupled to the frame; and
the cutting deck of claim 1 supported by the frame.

12. A cutting deck for a lawn mower, the cutting deck comprising:
a cutting deck pan having an upper wall, sidewalls extending downwardly from the upper wall, and a discharge opening defined in the sidewalls;
a first cutting blade rotatably mounted beneath the upper wall, the first cutting blade being configured to rotate within a first rotation zone;
a second cutting blade rotatably mounted beneath the upper wall, the second cutting blade being configured to rotate within a second rotation zone;
a baffle system coupled to the cutting deck pan and extending downwardly from the upper wall, the baffle system having a baffle wall that at least partially surrounds the first cutting blade and the second cutting blade to define a first cutting chamber and a second cutting chamber, the baffle wall comprises:
a rear baffle wall portion having a concave guide surface that forms a peak between the first cutting chamber and the second cutting chamber; and
a front baffle wall portion having a front guide surface having a transition area positioned between the second cutting chamber and the first cutting chamber and a curved segment that extends from the transition area to form an apex approximately midway within the first cutting chamber and proximate the first rotation zone, the curved segment being convex away from the first rotation zone.

13. The cutting deck of claim 12, wherein a tangential surface of the curved segment at the apex is parallel to a tangential surface of the first rotation zone proximate to the apex.

14. The cutting deck of claim 13, wherein the curved segment conforms to an outer circumference of a baffle wall circle having a first center point that is aligned with or offset relative to a second center point of the first rotation zone in a direction perpendicular to a direction of travel of the cutting deck, wherein the curved segment is concave towards the first center point of the baffle wall circle.

15. The cutting deck of claim 14, wherein the apex of the curved segment is offset less than three inches from the first blade rotation zone.

16. The cutting deck of claim 12, further comprising a discharge transition area positioned between the first cutting chamber and the discharge opening, wherein the discharge transition area is defined by a contoured segment of the baffle wall formed on the front guide surface that extends from the apex of the curved segment to the discharge opening.

17. The cutting deck of claim 16, wherein the discharge transition area is further defined by a linear segment of the baffle wall that extends from an end of the rear baffle wall portion to the discharge opening in a direction away from the front baffle wall portion.

18. The cutting deck of claim 17, wherein the contoured segment is positioned opposite the linear segment such that a size of the discharge opening increases away from the first cutting chamber.

19. The cutting deck of claim 18, wherein the concave guide surface of the first cutting chamber and the linear segment of the discharge transition area form a jog, and wherein the jog defines an angle that is less than 80 degrees.

20. A lawn mower comprising:
a frame;
a prime mover supported by the frame;
a plurality of ground engagement elements moveably coupled to the frame; and
the cutting deck of claim 12 supported by the frame.

21. The cutting deck of claim 1, wherein the discharge transition area is also defined by a linear segment of the baffle wall that extends from the end of the rear baffle wall portion to the discharge opening in a direction away from the front baffle wall portion, the contoured segment being positioned opposite the linear segment such that a size of the discharge opening increases away from the first and second cutting chambers.
